(19) United States
(12) Patent Application Publication
(10) Pub. No.: US 2018/0083505 A1
(43) Pub. Date: Mar. 22, 2018

(54) Divided Magnetic Generator

(71) Applicant: Shenzhen BaiCi Energy Co., Ltd., Shenzhen (CN)

(72) Inventor: Yi YANG, Shenzhen (CN)

(73) Assignee: Shenzhen BaiCi Energy Co., Ltd.

(21) Appl. No.: 15/362,680

(22) Filed: Nov. 28, 2016

(30) Foreign Application Priority Data
Sep. 19, 2016 (CN) 201610831916.0
Sep. 19, 2016 (CN) 201621062611.X

(51) Int. Cl. H02K 3/28; H02K 1/27; H02K 3/18

(52) U.S. Cl. CPC H02K 3/28; H02K 3/18; H02K 1/2786

(57) ABSTRACT

A divided magnetic electrical generator includes a driving shaft, a magnetic rotor, a plurality of claw pole stators, and a divided magnetic flux induction arrangement. The magnetic rotor includes a plurality of magnetic members formed on an inner peripheral boundary thereof for generating a corresponding magnetic field. The claw pole stators are mounted in the magnetic rotor. Each of the claw pole stators includes a plurality of claw poles spacedly distributed and extended along a 360° circumferential direction of the magnetic rotor. The divided magnetic flux induction arrangement includes a plurality of winding units received in the magnetic rotor, wherein when the magnetic rotor is driven to rotate at a low speed, the magnetic field in the magnetic rotor is arranged to be constantly and controllably altered so as to induce currents in the winding units.

### BACKGROUND OF THE PRESENT INVENTION

### Field of Invention

The present invention relates to an electrical engineering, and more particularly to an electrical generator comprising a divided magnetic flux induction arrangement.

### Description of Related Arts

Electrical energy is a major form of energy in modern society. Each society must build a certain number of generators and power plants to acquire electricity. A generator converts other forms of energy such as kinetic energy into electrical energy. Various forms of generators have been widely utilized in such fields as industrial productions, national defense and security, technology development as well as daily life of individuals.

There exist a wide variety of generators. The basic principle is that a rotor is driven to rotate with respect to a stator. Current-carrying conductors may be formed on one of both of the rotor or the stator as winding. The current in the winding set up magnetic fields and interact with the fields. Eventually, mechanical energy in the form of the rotation of the rotor is converted into electrical energy which may be stored in a battery.

In many situations, objects may rotate or move in a relatively low speed such as winds or water flowing at low speed. These forms of mechanical energy are naturally occurring and environmentally friendly. If one may utilize such natural mechanical energy and convert it into electrical energy, global energy shortage would be substantially mitigated. For conventional generators, in order to generate electricity, the rotors must be rotated at a speed above a particular threshold. Thus, conventional generators cannot utilize the naturally-occurring and environmentally friendly forms of mechanical energy to generate electrical energy.

### SUMMARY OF THE PRESENT INVENTION

An objective of the present invention is to provide an electrical generator which may effectively and efficiently generate electricity by low speed mechanical sources, such as low speed water flow or low speed air flow.

In one aspect of the present invention, it provides an electrical generator, comprising:

a driving shaft;

a magnetic rotor connected to the driving shaft in such a manner that the driving shaft is arranged to drive the magnetic rotor to rotate, the magnetic rotor comprising a plurality of magnetic members formed on an inner peripheral boundary thereof for generating a corresponding magnetic field in the magnetic rotor, each of the magnetic members having one of north polarity and south polarity;

a plurality of claw pole stators mounted in the magnetic rotor, each of the claw pole stators comprising a plurality of claw poles spacedly distributed and extended along a 360° circumferential direction of the magnetic rotor, each of the claw poles extending along a longitudinal direction of the driving shaft; and

a divided magnetic flux induction arrangement which comprises a plurality of winding units received in the magnetic rotor, wherein when the magnetic rotor is driven to rotate at a low speed, the magnetic field in the magnetic rotor is arranged to be constantly and controllably altered so as to induce currents in the winding units.

Furthermore, each of the claw pole stators has a plurality of claw pole portions, the claw poles being evenly distributed along a circumferential edge of the claw pole portions.

Furthermore, an angle of interval of each two adjacent claw poles is different from an angle of interval of each two adjacent claw pole portions.

Furthermore, each of the winding units is mounted in a space between the claw pole stators at a position on the corresponding claw pole portion, a number of the winding units being the same as a number of the claw pole portions.

Furthermore, the electrical generator comprises two claw pole stators, the claw pole stators being arranged to engage with and face each other such that each of the claw poles of one of the claw pole stators is positioned in space formed between two of the corresponding claw poles of another the claw pole stators, the winding units being positioned in a space surrounded by the two claw pole stators.

Furthermore, the claw pole stators has a center which coincides with a center of rotation of the magnetic rotor.

Furthermore, the winding units are positioned in a space between the two claw pole stators and surrounded by the claw poles.

Furthermore, the magnetic members are permanent magnets respectively, the permanent magnets being positioned along 360° circumferential inner boundary of the magnetic rotor.

Furthermore, the magnetic members are field windings respectively, the field windings being positioned along 360° circumferential inner boundary of the magnetic rotor.

The electrical generator further comprises a plurality of driving blades connected to the driving shaft, wherein natural force is allowed to drive the driving shaft to rotate through the moving driving blades.

An advantageous effect of the present invention is that by utilizing evenly distributed magnetic members and non-evenly distributed claw poles, the rotation of the magnetic members with respect to the claw pole stators induces currents in the winding units so as to generate electricity through slow rotation of the magnetic rotor.

### BRIEF DESCRIPTION OF THE DRAWINGS

FIG. 1 is a perspective view of a divided magnetic generator according to a first preferred embodiment of the present invention.

FIG. 2 is an exploded perspective view of the divided magnetic generator according to the first preferred embodiment of the present invention.

FIG. 3 is another exploded perspective view of the divided magnetic generator according to the first preferred embodiment of the present invention.

FIG. 4 is a schematic diagram of the divided magnetic generator according to the first preferred embodiment of the present invention.

FIG. 5 is another schematic diagram of the divided magnetic generator according to the first preferred embodiment of the present invention.

FIG. 6 is a top view of the divided magnetic generator according to the first preferred embodiment of the present invention, illustrating that one stator unit is received in a magnetic rotor.

FIG. 7 is a top view of the divided magnetic generator according to the first preferred embodiment of the present invention, illustrating that the stator unit and a winding assembly are received in the magnetic rotor.

FIG. 8 is a perspective view of the divided magnetic generator according to a second preferred embodiment of the present invention.

FIG. 9 is an exploded perspective view of a divided magnetic generator according to the second preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention. Each of the inventive features described below can be used independently of one another or in combination with other features.

It is worth mention that when a first element is said to be “connected” to a second element, the first element may be directly connected to the second element, or through intervening or immediate elements. When a first element is said to be “directly connected” to a second element, the first element is directly connected to the second element without any intervening or immediate element. The terms “horizontal”, “vertical”, “left”, “right” used in the following descriptions are for description of the present invention only.

Unless otherwise specified, the technical terms used in the following descriptions are within the understanding of one skilled in the art. The electrical generator described below is for description of the preferred embodiments and are not intended to be limiting. The word “and/or” includes one or more, or a combination of the corresponding elements.

### Embodiment 1

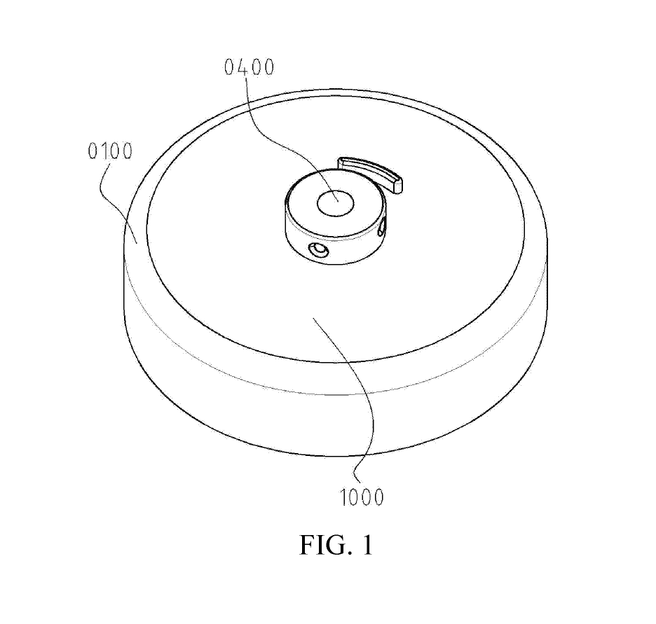

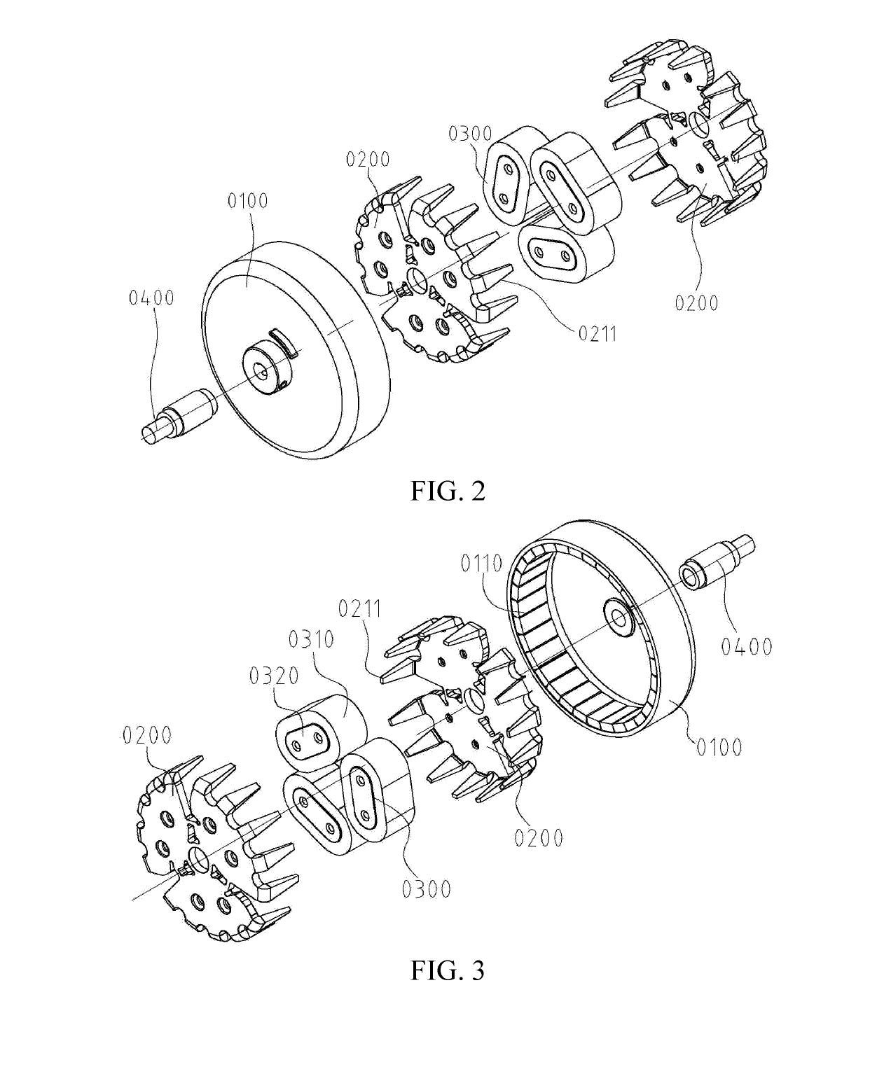

Referring to FIG. 1 to FIG. 2 of the drawings, an electrical generator according to a preferred embodiment of the present invention is illustrated. Broadly, the electrical generator comprises a magnetic rotor 0100, and a plurality of claw pole stators 0200. The magnetic rotor 0100 is an annular-shaped magnetic pole. The magnetic rotor 0100 is rotatably connected to a driving shaft 0400. Each of the claw pole stators 0200 comprises a plurality of claw poles extended in 360° along a circumferential direction of the magnetic rotor 0100. The electrical generator further comprises a divided magnetic flux induction arrangement which comprises a plurality of winding units 0300.

Each of the winding units 0300 a winding core 0320 and a plurality of winding coils 0310 formed on the winding core 0320. The winding core 0320 may be configured from magnetic and conductive material. The winding core 0320 is magnetically communicated with the corresponding permanent magnets 0110 formed on the magnetic rotor 0100. The winding coils 0310 are exposed to the magnetic field generated by the permanent magnets 0110 and the corresponding winding core 0320. As shown in FIG. 3 of the drawings, the three winding units 0300 are connected in an end-to-end manner so as to form a substantially triangular configuration. The winding units 0300 are positioned correspond to the claw pole stators 0200.

The magnetic rotor 0100 is connected to the driving shaft 0400 in such a manner that the driving shaft 0400 is arranged to drive the magnetic rotor 0100 to rotate. The rotation of the magnetic rotor 0100 creates a relative movement between the magnetic rotor 0100 and the winding units 0300. The winding units 0300 are arranged to interfere or cut the magnetic field generated between the magnetic rotor 0100 and the winding core 0320. Currents are then induced in the winding coils 0310.

Generally speaking, there must exist a stable relative movement between the winding units 0300 and the magnetic rotor 0100 in order to produce a stable output current. The currents thus produced must exceed a certain threshold before they could be outputted for use through an output circuit.

Lenz's law states that the polarity of the induced voltage is such that the voltage would produce a current that opposes the original change in flux linkages. Since the change in magnetic field is produced by the rotation of the magnetic rotor 0100, the magnetic rotor 0100 may experience a predetermined amount of hindering force which tends to oppose the rotational movement of the magnetic rotor 0100, and this phenomenon may severely affect the performance and efficiency of the electrical generator of the present invention. In order to minimize the effects of these problems, each of the winding units 0300 may be arranged to exert a different amount of hindering force to the magnetic rotor 0100. The hindering force exerted by the winding units 0300 may cancel with each other so as to minimize the total Hindering force exerted on the magnetic rotor 0100 so as to maximize the efficiency of the winding units 0300.

Specifically, when the magnetic rotor 0100 is rotating at a relatively low speed, the work inputted to the driving shaft 0400 will be relatively lower. If the hindering force to the magnetic rotor 0100 is too large, the winding units 0300 are not capable of producing a usable amount of outputted currents. Therefore, the efficiency of the winding units 0300 is of overriding important and this is affected by the hindering force exerted on the magnetic rotor 0100.

As a result, the claw pole stators 0200 are communicate with a plurality of winding units 0300 which is arranged to exert a different amount of hindering force to the magnetic rotor 0100. These hindering force may cancel each other so that the overall hindering force exerted on the magnetic rotor 0100 may be minimized.

The claw poles 0211 of the claw pole stators 0200 are not evenly distributed along a 360° circumferential direction of the magnetic rotor 0100. The claw poles 0211 are exposed to the magnetic field developed between the magnetic rotor 0100 and the claw pole stators 0200 and exert certain magnetic force to the magnetic rotor 0100. On the other hand, the winding units 0300 may also exert different amount of magnetic force to the magnetic rotor 0100 so that the forces exerted by the winding units 0300 and the claw poles 0211 may cancel with each other, and this minimize the overall Hindering force exerted on the magnetic rotor 0100. The claw pole stators 0200 has a center which coincides with a center of rotation of the magnetic rotor 0100.

According to the above arrangement, the loss to the work inputted to the driving shaft 0400 may also be minimized. As such, the present invention is capable of generating a substantial amount of electricity even when the magnetic rotor 0100 is driven to rotate at low speed. The Hindering force developed during the relevant electromagnetic induction process may be effectively minimized. A very large proportion of work inputted to the driving shaft 0400 are converted to electricity by the winding units 0300.

Obviously, the above-mentioned arrangement effectively improve the efficiency and the electricity conversion rate of the winding units 0300, and because of this, a substantial amount of electricity may be generated even when the magnetic rotor 0100 is rotating at a relatively speed.

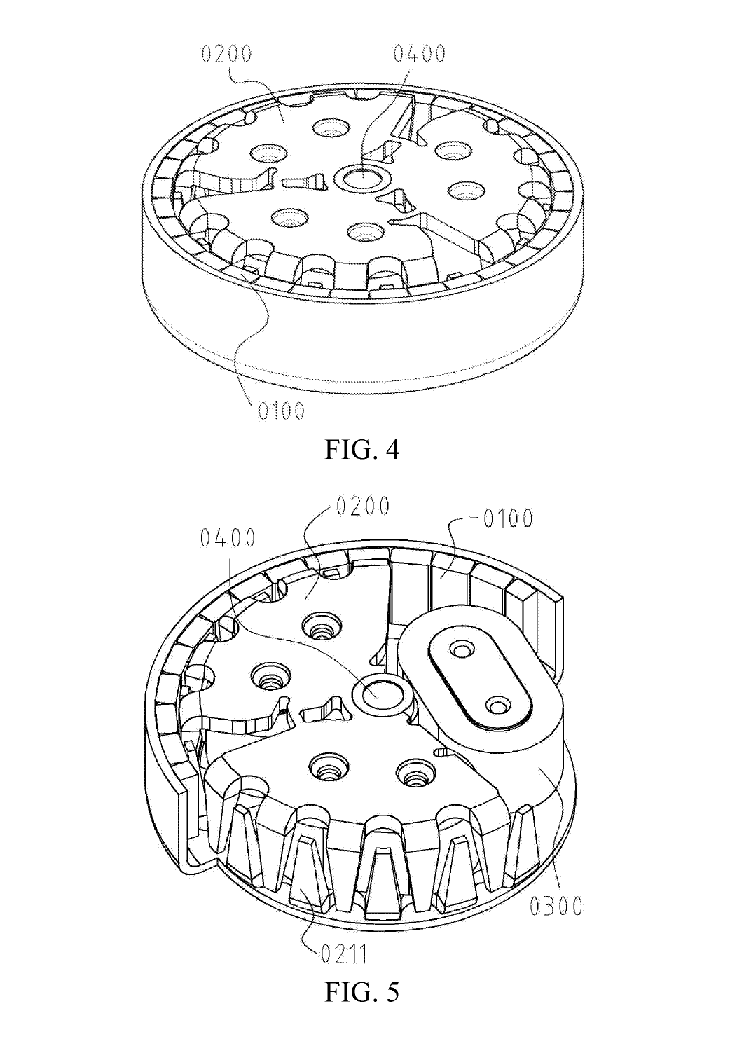

Referring to FIG. 3 to FIG. 5 of the drawings, there are two claw pole stators 0200. The claw pole stators 0200 are arranged such that each of the claw poles 0211 of one claw pole stator 0200 can be positioned or inserted in a space created between two claw poles 0211 of another claw pole stator 0200. The claw pole stators 0200 are arranged to engage with and face each other so that the winding units 0300 are positioned in a space surrounded by the two claw pole stators 0200. This arrangement may minimize any Hindering force exerted on the magnetic rotor 0100 so as to substantially improve the performance of the electrical generator of the present invention. The claw pole 0211 are configured from metallic or magnetic materials so that the claw poles 0211 are magnetized when they are in a magnet field.

Further, the magnetic rotor 0100 is configured to have a cylindrical structure. The magnetic rotor 0100 comprises a plurality of magnetic members such as a plurality of permanent magnets 0110 formed on an inner peripheral boundary of the magnetic rotor 0100 in 360° for generating a corresponding magnetic field. The permanent magnets 0110 are evenly distributed along the entire inner peripheral boundary of the magnetic rotor 0100. The claw pole stators 0200 are distributed concentrically with respect to the permanent magnets 0110 while the winding units 0300 are received in a space formed between the two claw pole stators 0200.

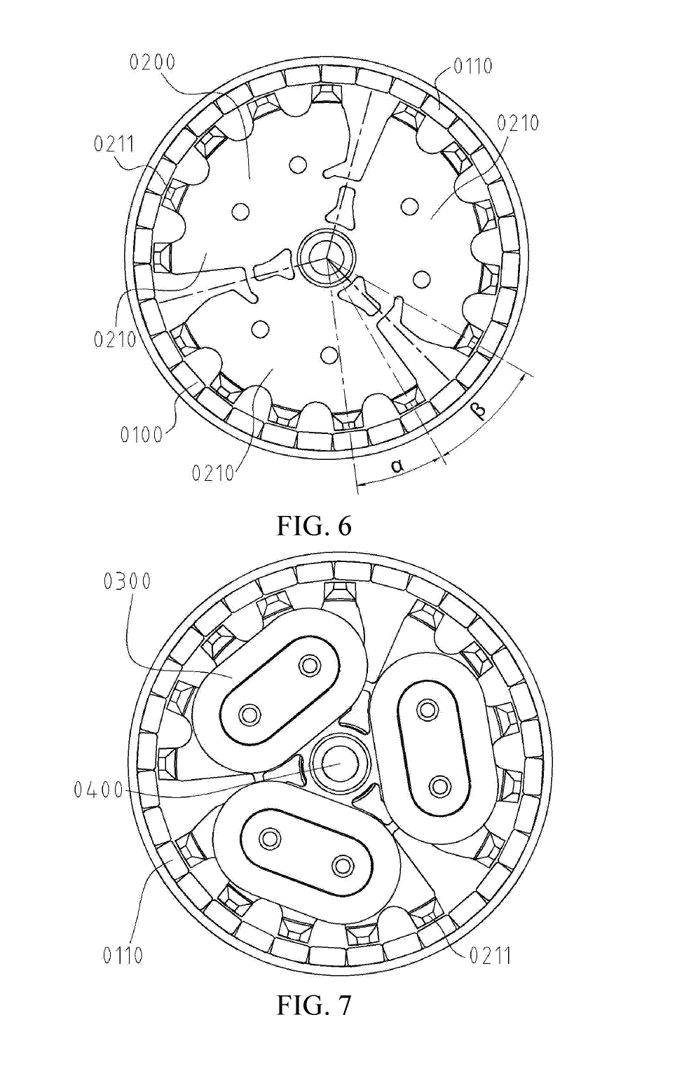

Referring to FIG. 6 of the drawings, the magnetic rotor 0100 may comprise a total of thirty two permanent magnets 0110 which may be 360° evenly distributed along the inner peripheral boundary of the magnetic rotor 0100. The utilization of thirty two permanent magnets 0110 may optimize the performance of the electrical generator and may minimize the Hindering force exerted on the magnetic rotor 0100.

The claw poles 0211 of each of the claw pole stators 0200 may be divided into a plurality of claw pole portions 0210 each having a predetermined number of claw poles 0211. The claw pole portions 0210 are 360° evenly distributed along a circumference of the corresponding claw pole stator 0200.

For each of the claw pole portions 0210, the claw poles 0211 are evenly distributed alone a corresponding circumference of the corresponding claw pole stator 0200.

Each of the claw poles 0221 are evenly distributed along an outer circumferential edge of the corresponding claw pole portion 0210 of the corresponding claw pole stator 0200. The two side edges of each of the claw pole portion 0210 form a predetermined angle of interval with respect to the center of the magnetic rotor 0100.

As shown in FIG. 6 of the drawings, an angle of interval of two adjacent claw poles 0221 in the same claw pole portion 0210 may be designated as •, whereas an angle of interval between two adjacent claw poles 0221 in two adjacent claw pole portions 0210 may be designated as β. In this preferred embodiment, α and β have different valves. In this preferred embodiment, for each particular claw pole portion 0210, the value of α is identical, while for the entire main claw pole stator 0200, the value of each β is identical.

Since α and β have different valves, the claw poles 0221 and the permanent magnets 0110 may not have a constant or stable spatial relationship. Since the magnetic rotor 0100 may be driven to rotate at a constant speed, the magnetic flux between the permanent magnets 0110 and the claw poles 0221 will be changing all the time, and this helps in canceling the Hindering force for the magnetic motor 0100.

Each claw pole stators 0200 has three claw pole portions 0210 evenly distributed along 360° circumferential direction of the claw pole stator 0200. There are three winding units 0300 supported by the three separate spaces formed by the three claw pole portions 0210 of the corresponding two claw pole stator 0200 respectively. Each two claw pole portions 0210 may have the same angle of interval β.

Each of the claw pole portions 0210 may have a total of five claw poles 0211. The number of claw poles 0211 may be varied depending on manufacturing and operation circumstances. Each two of the claw poles 0211 on the same claw pole portion 0210 has an identical angle of interval α.

In the preferred embodiment of the present invention, a may approximately equal to 22.5°, while β may approximately equal to 30°. The magnetic rotor 0100 may be driven to rotate at a rotational speed of approximately one revolution per minute.

When the magnetic rotor 0100 is rotated such that the five claw poles 0211 coincide with the permanent magnets 0110 respectively, a magnetic field having the maximum strength occurs, and the corresponding winding units 0300 may have the maximum amount of induced currents.

Referring to FIG. 7 of the drawings, each of the claw pole portions 0210 may be attached with one winding unit 0300 so that if there are three claw pole portions 0210, there will be three winding units 0300. The number of claw pole portions 0210 for each of the claw pole stator 0200 may be identical. This arrangement may help to maximize power generating performance and at the same time minimize the Hindering force experienced by the magnetic rotor 0100. Alternatively, the number of winding units 0300 may be a multiple of the number of the claw pole portions 0210.

Specifically, there are three claw pole portions 0210, and three winding units 0300. The winding units 0300 are received in the three claw pole portions 0210 of the claw pole stators 0200 respectively.

The magnetic rotor 0100, the claw pole stators 0200 may have the same axis of rotation so that the magnetic rotor 0100 and the claw pole stators 0200 may have concentric and stable relative movement.

When the magnetic rotor 0100 is driven to rotate such that when the claw pole 0211 of one of the claw pole stators 0200 coincide with the permanent magnets 0110 having N polarity respectively, the claw poles 0211 of the claw pole stator 0200 may coincide with the permanent magnets 0110 having S polarity respectively. For each of the claw pole portions 0210, magnetic flux lines leave the N poles of the corresponding permanent magnets 0110, pass through the corresponding claw poles 0211, the corresponding winding core 0320, and enter the S poles of the corresponding permanent magnets 0110. Since the magnetic rotor 0100 is constantly rotating, and this causes change in the magnetic field experienced by the corresponding winding unit 0300 as each permanent magnet 0110 passes through each claw pole 0221. The change in magnetic field experienced by the winding units 0300 induce current in the winding coils 0310. The currents may be eventually stored and used as newly generated electricity. The newly generated electricity may be in the form of alternating currents. The three winding units 0300 may generate alternating currents with equal magnitude but different phase angles.

In this preferred embodiment of the present invention, each of the winding units 0300 is arranged to output a current impulse when the magnetic rotor 0100 has turned approximately 11.25°. In other words, there are altogether 96 current impulses which may be outputted by the three winding units 0300 when the magnetic rotor 0100 has turned one complete circle. Furthermore, the magnetic rotor 0100 may be driven to rotate at a constant speed for providing a stable current output.

### Embodiment 2

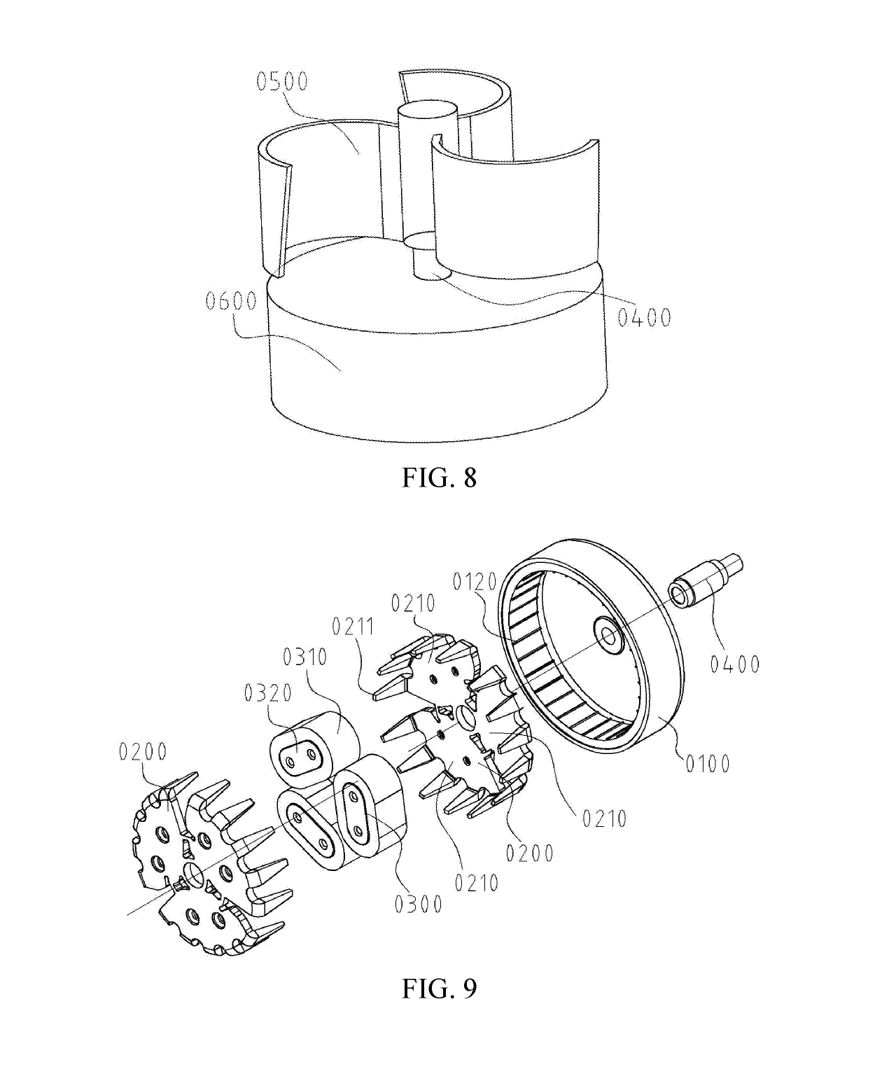

Referring to FIG. 8 of the drawings, the electrical generator according to a second preferred embodiment of the present invention is illustrated. According to the second preferred embodiment, the electrical generator comprises a magnetic rotor 0100, and a plurality of claw pole stators 0200. The magnetic rotor 0100 is an annular-shaped magnetic pole. The magnetic rotor 0100 is rotatably connected to a driving shaft 0400. Each of the claw pole stators 0200 comprises a plurality of claw poles extended in 360° along a circumferential direction of the magnetic rotor 0100. The electrical generator further comprises a plurality of field windings 0120.

Further, the magnetic rotor 0100 is configured to have a cylindrical structure. The magnetic rotor 0100 comprises a plurality of magnetic members such as a plurality of field windings 0120 formed on an inner peripheral boundary of the magnetic rotor 0100 in 360° circumferential direction for generating a corresponding magnetic field. The field windings 0120 are evenly distributed along the entire inner peripheral boundary of the magnetic rotor 0100.

The claw pole stators 0200 are distributed concentrically with respect to the field windings 0120 while the winding units 0300 are received in a space formed between the two claw pole stators 0200. Each of the claw pole stators 0200 has a plurality of claw pole portions 0210, and a plurality of claw poles 0211, wherein for each of the claw pole portions 0210, the claw poles 0211 are evenly distributed along a circumferential edge of the corresponding claw pole portion 0210 on the corresponding claw pole stator 0200.

The electrical generator has two claw pole stators 0200. The claw pole stators 0200 are arranged such that each of the claw poles 0211 of one claw pole stator 0200 can be positioned or inserted in a space created between two claw poles 0211 of another claw pole stator 0200. The claw pole stators 0200 are arranged to engage with and face each other so that the winding units 0300 are positioned in a space surrounded by the two claw pole stators 0200.

Referring to FIG. 9 of the drawings, the electrical generator may further comprise a plurality of driving blades 0500 wherein natural forces, such as slow flowing water or air, may drive the driving blades 0500 to rotate through exerting forces thereon. The driving shaft 0400 may then drive the magnetic rotor 0100 to rotate so as to generate electricity in a manner described above.

Since water or air may flow at a very low speed, the above-mentioned structure such as the pole claw stators 0200 and the winding units 0300 of the electrical generator may utilize such natural forces to effectively generate electricity.

The electrical generator may further comprise a protective casing 0600 mounted on the magnetic rotor 0100 for physically protecting the magnetic rotor 0100, the stator assembly 0200, and the winding units 0300.

The present invention, while illustrated and described in terms of a preferred embodiment and several alternatives, is not limited to the particular description contained in this specification. Additional alternative or equivalent components could be used to practice the present invention.

What is claimed is:

1. An electrical generator, comprising:
a driving shaft;
a magnetic rotor connected to said driving shaft in such a manner that said driving shaft is arranged to drive said magnetic rotor to rotate, said magnetic rotor comprising a plurality of magnetic members formed on an inner peripheral boundary thereof for generating a corresponding magnetic field in said magnetic rotor, each of said magnetic members having one of north polarity and south polarity;
a plurality of claw pole stators mounted in said magnetic rotor, each of said claw pole stators comprising a plurality of claw poles spacedly distributed and extended along a 360° circumferential direction of said magnetic rotor, each of said claw poles extending along a longitudinal direction of said driving shaft; and
a divided magnetic flux induction arrangement which comprises a plurality of winding units received in said magnetic rotor, wherein when said magnetic rotor is driven to rotate at a low speed, said magnetic field in said magnetic rotor is arranged to be constantly and controllably altered so as to induce currents in the winding units.

2. The electrical generator, as recited in claim 1, wherein each of said claw pole stators has a plurality of claw pole portions, said claw poles being evenly distributed along a circumferential edge of said claw pole portions.

3. The electrical generator, as recited in claim 2, wherein an angle of interval of each two adjacent claw poles is different from an angle of interval of each two adjacent claw pole portions.

4. The electrical generator, as recited in claim 2, wherein each of said winding units is mounted in a space between said claw pole stators at a position on said corresponding claw pole portion, a number of said winding units being the same as a number of said claw pole portions.

5. The electrical generator, as recited in claim 1, comprising two claw pole stators, said claw pole stators being arranged to engage with and face each other such that each of said claw poles of one of said claw pole stators is positioned in space formed between two of said corresponding claw poles of another said claw pole stators, said winding units being positioned in a space surrounded by said two claw pole stators.

6. The electrical generator, as recited in claim 1, wherein said claw pole stators has a center which coincides with a center of rotation of said magnetic rotor.

7. The electrical generator, as recited in claim 1, wherein said winding units are positioned in a space between said two claw pole stators and surrounded by said claw poles.

8. The electrical generator, as recited in claim 1, wherein said magnetic members are permanent magnets respectively, said permanent magnets being positioned along 360° circumferential inner boundary of said magnetic rotor.

9. The electrical generator, as recited in claim 1, wherein said magnetic members are field windings respectively, said field windings being positioned along 360° circumferential inner boundary of said magnetic rotor.

10. The electrical generator, as recited in claim 1, further comprising a plurality of driving blades connected to said driving shaft, wherein natural force is allowed to drive said driving shaft to rotate through said moving driving blades.
